(19) United States
(12) Patent Application Publication
(10) Pub. No.: US 2004/0062139 A1
(43) Pub. Date: Apr. 1, 2004

(54) Soluble stir stick

(76) Inventor: Steve S. Pretious, Alberta (CA)

Correspondence Address: JOHN J. ELNITSKI, JR., 225 A SNOWBIRD LANE, BELLEFONTE, PA, 16823, US

(21) Appl. No.: 10/065,218

(22) Filed: Sep. 26, 2002

(51) Int. Cl. B01F 1/00

(52) U.S. Cl. 366/129

(57) ABSTRACT

A soluble stir stick composed of an edible material that is soluble in a beverage. The soluble stir stick is especially useful with hot beverages such as coffee or tea. The consumer stirs their hot beverage with the soluble stir stick and the soluble stir stick dissolves into the beverage, resulting in no waste. The soluble stir stick can be a solid stick made from one main soluble material. The soluble stir stick can be flavored or unflavored. For example, such flavorings could be chocolate or vanilla. The main soluble material of the soluble stir stick can also encapsulate columns of additives for the beverage.

### BACKGROUND OF INVENTION

The present invention generally relates to apparatuses for stirring a beverage and additives for a beverage. More specifically, the present invention relates to a combination of stirring apparatuses with beverage additives.

There are many beverages, in which the consumer of the beverage uses additives to adjust the taste of the beverage to suit the consumer”s personal taste. Associated with the use of these additives is the use of a stirring device to mix in the additives with the beverage. In office environments such as the coffee room or the office kitchen, it is common to use stir sticks rather than spoons for the stirring of hot beverages. Often the coffee rooms will include sugar, coffee whitener or cream packets as additives for the hot beverages. The stir stick, sugar package and cream packet is then discarded, creating undesirable waste and associated costs.

The combining of a stir stick and additives has been accomplished, where a non-soluble stir stick includes one or more additives which are released into the beverage. Some of the non-soluble stir sticks include a release mechanism which is activated when the non-soluble stir stick is placed in the beverage, while others require the removal of a tab to release the additive before placing the non-soluble stir stick. Afterwards, the non-soluble stir stick remains to be disposed of or is left to clutter the room by inconsiderate consumers.

It is an object of the present invention to provide a soluble stir stick which to stir a beverage in which the soluble stir stick dissolves in the beverage and does not leave any waste.

It is another object of the present invention to provide a soluble stir stick which includes additives to stir a beverage in which the additives dissolve in the beverage along with the soluble stir stick.

### SUMMARY OF INVENTION

A soluble stir stick composed of an edible material that is soluble in a beverage. The soluble stir stick is especially useful with hot beverages such as coffee or tea. The consumer stirs their hot beverage with the soluble stir stick and the soluble stir stick dissolves into the beverage, resulting in no waste. The soluble stir stick can be a solid stick made from one main soluble material. The soluble stir stick can be flavored or unflavored. For example, such flavorings could be chocolate or vanilla. The main soluble material of the soluble stir stick can also encapsulate columns of additives for the beverage.

### BRIEF DESCRIPTION OF DRAWINGS

FIG. 1 is a perspective view of a soluble stir stick according to the present invention;

FIG. 2 is a perspective view of a soluble stir stick with two additives according to the present invention;

FIG. 3 is a cross-sectional view of the soluble stir stick of FIG. 1 according to the present invention; and

FIG. 4 is a perspective view of the soluble stir stick with more than two additives according to the present invention.

### DETAILED DESCRIPTION

The present invention is a soluble stir stick composed of an edible material that is soluble in a fluid. The soluble stir stick is especially useful with hot beverages such as coffee or tea. The consumer stirs their hot beverage with the soluble stir stick and the soluble stir stick dissolves into the beverage, resulting in no waste.

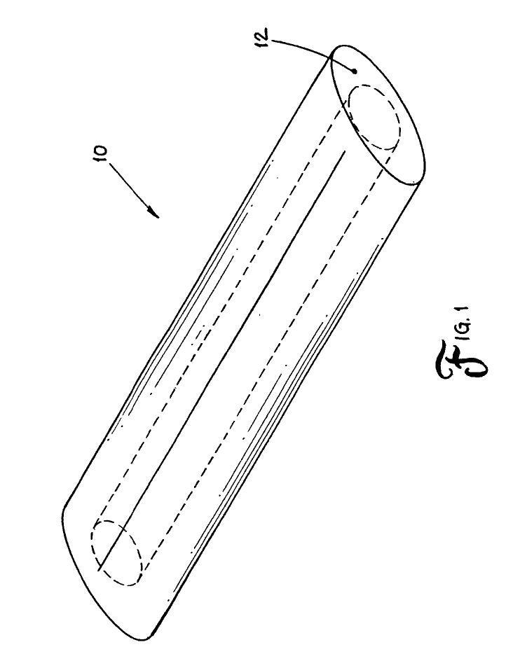

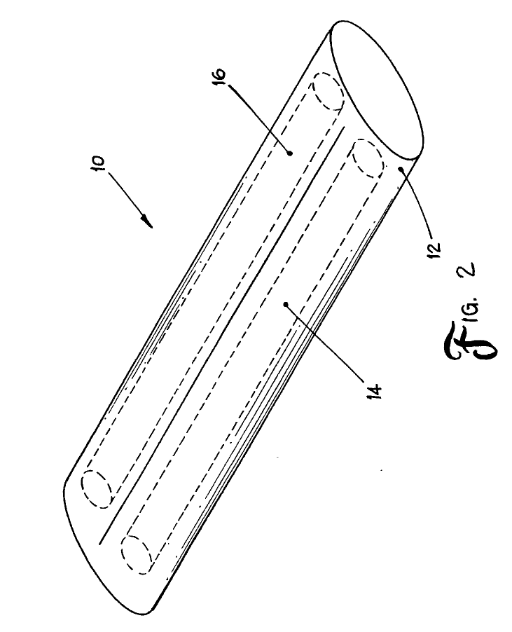

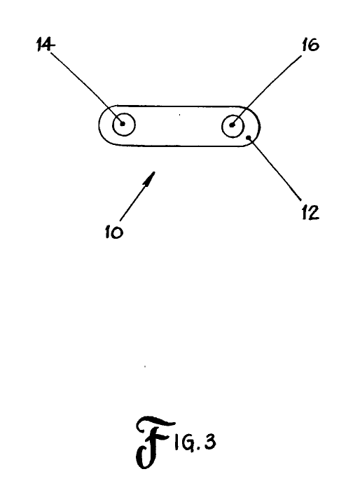

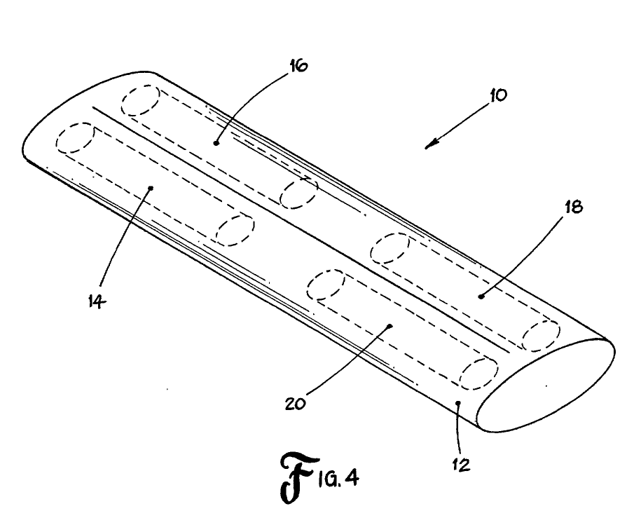

FIGS. 1-4 show the soluble stir stick 10. FIG. 1 shows the soluble stir stick 10 as a solid stick made from one main soluble material 12. As is the case with all of the soluble stir stick 10s shown, the main soluble material 12 can be flavored or unflavored. For example, such flavorings could be chocolate or vanilla. FIGS. 2-4 show the main soluble material 12 of the soluble stir stick 10 encapsulating columns of additives for the beverage. FIG. 2 shows the soluble stir stick 10 with a first column of additive 14 and a second column of additive 16 encapsulated by the main soluble material 12. FIG. 3 shows a cross-section of the soluble stir stick 10 shown in FIG. 2. FIG. 4 shows the soluble stir stick 10 with a first column of additive 15, a second column of additive 16, a third column of additive 18 and a fourth column of additive 20 encapsulated by the main soluble material 12.

The columns of additives could be for example, sugar, sweetener, whitener or a combination thereof. The consumer who desires cream and sugar in their beverage, would simply select a soluble stir stick containing these columns of additives in the interior of the soluble stir stick. By stirring in a hot beverage, the soluble stir stick dissolves along with the additives, which are dispersed into the beverage. This is more convenient than the traditional methods and avoids the waste of the sugar or whitener containers. Furthermore, if the consumer desired a smaller portion of whitener or sugar, one could break off half of the soluble stir stick, reducing its concentration of whitener or sugar. Alternatively, the consumer could stir the hot beverage with the soluble stick, until only the bottom half is dissolved, then save or discard the top half, reducing the concentration once again. If the upper half is disposed, it is a biodegradable material versus the plastics of cream containers and current stir sticks. Therefore, the soluble stir stick reduces many of the wastes associated with additives and current stir sticks used in office coffee rooms and kitchens.

While different embodiments of the invention have been described in detail herein, it will be appreciated by those skilled in the art that various modifications and alternatives to the embodiments could be developed in light of the overall teachings of the disclosure. Accordingly, the particular arrangements are illustrative only and are not limiting as to the scope of the invention that is to be given the full breadth of any and all equivalents thereof.

1. A soluble stir stick, for use with a beverage, comprising a stick of main soluble material, said main soluble material being soluble in the beverage.

2. The soluble stir stick of claim 1, wherein said main soluble material is flavored.

3. The soluble stir stick of claim 1, wherein said main soluble material encapsulates at least one additive, said at least one additive soluble in the beverage.

4. The soluble stir stick of claim 3, wherein said main soluble material is flavored.

5. The soluble stir stick of claim 1, wherein said main soluble material encapsulates at least two additives, said at least two additives soluble in the beverage.

6. The soluble stir stick of claim 5, wherein said main soluble material is flavored.

7. The soluble stir stick of claim 5, wherein one additive is a sweetener and another additive is a whitener.

8. The soluble stir stick of claim 7, wherein said main soluble material is flavored.

9. The soluble stir stick of claim 1, wherein said main soluble material encapsulates more than two additives, said more than two additives soluble in the beverage.

10. The soluble stir stick of claim 9, wherein said main soluble material is flavored.

11. The soluble stir stick of claim 9, wherein one additive is a sweetener and another additive is a whitener.

12. The soluble stir stick of claim 11, wherein said main soluble material is flavored.
